(19) United States
(12) Patent Application Publication
(10) Pub. No.: US 2026/0095923 A1
(43) Pub. Date: Apr. 2, 2026

(54) CONFIGURATION OF SIDELINK TRANSMISSION

(71) Applicant: Lenovo (Singapore) Pte. Limited, Singapore (SG)

(72) Inventors: Alexander Golitschek Edler von Elbwart, Darmstadt (DE); Karthikeyan Ganesan, Nauheim (DE); Joachim Löhr, Wiesbaden (DE); Prateek Basu Mallick, Dreieich (DE)

(73) Assignee: Lenovo (Singapore) Pte. Limited, Singapore (SG)

(21) Appl. No.: 19/111,248

(22) PCT Filed: Sep. 25, 2023
(86) PCT No.: PCT/IB2023/059473

§ 371 Date: Mar. 12, 2025

Related U.S. Application Data
(60) Provisional application No. 63/409,949, filed on Sep. 26, 2022.

(51) Int. Cl. H04W 72/25; H04L 27/26

(52) U.S. Cl. CPC H04W 72/25; H04L 27/2678

(57) ABSTRACT

Various aspects of the present disclosure relate to methods, apparatuses, and systems that support configuration for sidelink transmission. The disclosure, for example, describes ways for determining sidelink transmission offset as a function of sidelink transmission priority. For instance, sidelink transmission offset may be determined as a positive offset value from a symbol boundary time and/or a negative offset value from a symbol boundary time.

### RELATED APPLICATION

This application claims priority to U.S. Provisional Application Ser. No. 63/409,949, filed 26 Sep. 2022 entitled “CONFIGURATION OF SIDELINK TRANSMISSION,” the disclosure of which is incorporated by reference herein in its entirety.

### TECHNICAL FIELD

The present disclosure relates to wireless communications, and more specifically to sidelink transmission in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide techniques for sidelink transmissions over unlicensed carrier frequencies. Such techniques, however, may be unable to account for transmission priority for sidelink transmissions.

### SUMMARY

The present disclosure relates to methods, apparatuses, and systems that support configuration for sidelink transmission. The disclosure, for example, describes ways for determining sidelink transmission offset as a function of sidelink transmission priority. For instance, sidelink transmission offset may be determined as a positive offset value from a symbol boundary time and/or a negative offset value from a symbol boundary time.

By utilizing the described techniques, sidelink frequency resources (e.g., in unlicensed spectrum) may be more efficiently utilized while reducing signal interference in such sidelink frequency resources.

Some implementations of the methods and apparatuses described herein may further include generating, at a first apparatus, a transmission; and transmitting, by the first apparatus, the transmission over a sidelink resource and at a first time instant, the first time instant determined from a symbol boundary time instant and a first start transmission time offset, and the first start transmission time offset is determined based at least in part on a first transmission priority for the transmission.

Some implementations of the methods and apparatuses described herein may further include where the sidelink resource occurs in unlicensed spectrum; the symbol boundary includes a slot boundary; the first start transmission time offset for the first transmission priority is smaller than a second transmission time offset for a second transmission priority, and where the first transmission priority is higher than the second transmission priority; further including determining whether the sidelink resource is reserved by a second apparatus; and determining the first start transmission time offset as a non-zero value based at least in part on a determination that the sidelink resource is reserved by a different apparatus; further including determining whether the first transmission priority exceeds a transmission priority threshold; and determining the first start transmission time offset as a non-zero value based at least in part on a determination that the first transmission priority exceeds the transmission priority threshold

Some implementations of the methods and apparatuses described herein may further include implementing the first start transmission time offset using a cyclic prefix extension if the first start transmission time offset has a negative value; further including performing a clear channel assessment for the sidelink resource before transmitting the transmission over the sidelink resource; further including determining the first transmission priority based at least in part on a resource pool for the sidelink resource; further including transmitting the transmission over the sidelink resource and at the first time instant based at least in part on a failure of a clear channel assessment at a second time instant and a success of a clear channel assessment at the first time instant; further including determining the first time instant as occurring before the symbol boundary time instant; further including receiving, from a second apparatus, a notification to apply the first start transmission time offset based at least in part on the first transmission priority.

Some implementations of the methods and apparatuses described herein may further include generating, by a first apparatus, a notification including one or more transmission priorities for sidelink transmissions and one or more transmission time offsets to be applied to one or more sidelink transmissions associated with the one or more transmission priorities; and transmitting the notification to a second apparatus.

Some implementations of the methods and apparatuses described herein may further include where the notification indicates that the one or more transmission priorities and the one or more transmission time offsets are to be applied for the one or more sidelink transmissions over unlicensed spectrum; the notification includes a first transmission priority associated with a first transmission time offset and a second transmission priority associated with a second transmission time offset; the first transmission priority is higher than the second transmission priority; and the first transmission time offset is smaller than the second transmission time offset; the notification further includes an indication that when a sidelink resource for a sidelink transmission is determined to be reserved by a third apparatus, the second apparatus is to determine a transmission time offset as a non-zero value.

Some implementations of the methods and apparatuses described herein may further include where the notification further includes an indication that when a transmission priority exceeds a transmission priority threshold, the second apparatus is to determine a transmission time offset as a non-zero value; notification further includes an indication to implement at least one transmission time offset using a cyclic prefix extension; In some aspects, the techniques described herein relate to method, where the notification further includes an indication of association of the one or more transmission priorities with a resource pool for the sidelink transmissions; the notification further includes an indication that at least one transmission time offset is applicable to determine a time instant that occurs before a symbol boundary time instance for a sidelink transmission; further including transmitting the notification via radio resource control (RRC) signaling.

### BRIEF DESCRIPTION OF THE DRAWINGS

FIG. 1 illustrates an example of a wireless communications system that supports configuration of sidelink transmission in accordance with aspects of the present disclosure.

FIG. 2 illustrates an Orthogonal Frequency Division Multiplexing (OFDM) symbol in which a cyclic prefix is added such as for mitigation of inter-symbol interference.

FIG. 3 illustrates an OFDM symbol in which a cyclic prefix is added such as for mitigation of inter-symbol interference in unlicensed carriers.

FIG. 4 illustrates a scenario where a sidelink UE may start transmission before a start of a symbol boundary in accordance with aspects of the present disclosure.

FIG. 5 illustrates a scenario where a sidelink (SL) transmission may start after a symbol boundary in accordance with aspects of the present disclosure.

FIG. 6 illustrates a scenario where SL transmission starts before a symbol boundary in accordance with aspects of the present disclosure.

FIGS. 7 and 8 illustrate examples of block diagrams of devices that support configuration of sidelink transmission in accordance with aspects of the present disclosure.

FIGS. 9 through 12 illustrate flowcharts of methods that support configuration of sidelink transmission in accordance with aspects of the present disclosure.

### DETAILED DESCRIPTION

In some wireless communications systems, ways are provided for techniques for sidelink transmissions over unlicensed carrier frequencies. Such techniques, however, may be unable to account for transmission priority for sidelink transmissions.

Accordingly, this disclosure provides for techniques that support configuration of sidelink transmission. For instance, ways are provided for determining sidelink transmission offset as a function of sidelink transmission priority. For instance, sidelink transmission offset may be determined as a positive offset value from a symbol boundary time and/or a negative offset value from a symbol boundary time.

By utilizing the described techniques, sidelink frequency resources (e.g., in unlicensed spectrum) may be more efficiently utilized while reducing signal interference in such sidelink frequency resources.

Aspects of the present disclosure are described in the context of a wireless communications system. Aspects of the present disclosure are further illustrated and described with reference to device diagrams and flowcharts.

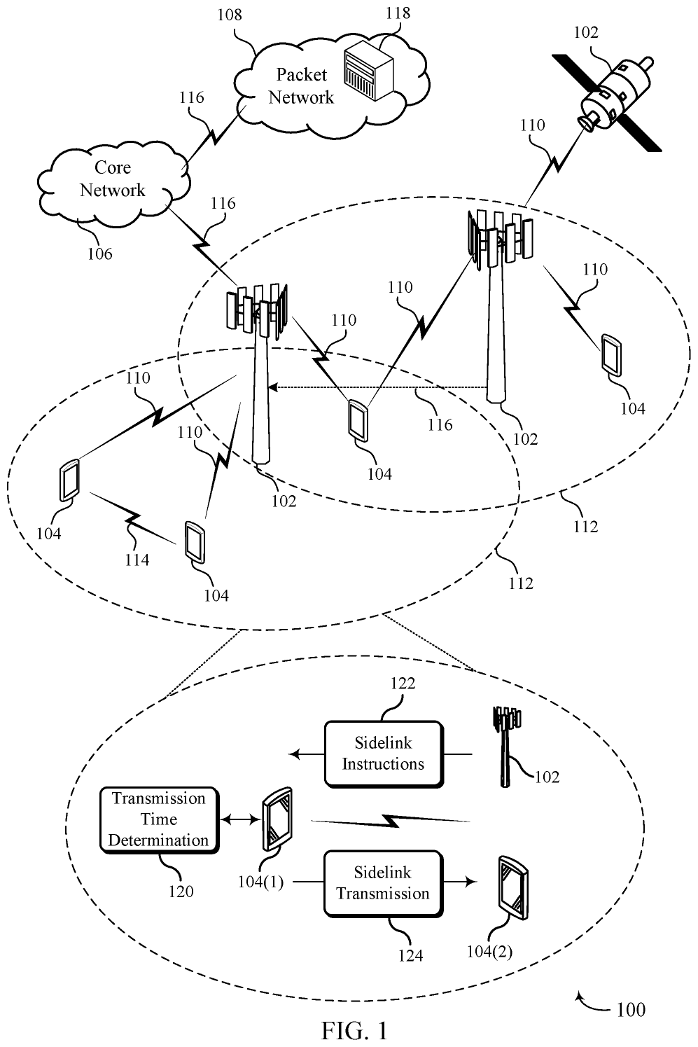

FIG. 1 illustrates an example of a wireless communications system 100 that supports configuration of sidelink transmission in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., PHY layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for configuration of sidelink transmission, a UE 104(1) can perform transmission time determination 120 to determine a time instant for sidelink transmission. The transmission time determination 120, for instance, is based on a priority for a sidelink transmission and can be determined based on a start transmission time offset applied to a symbol boundary time instant. The transmission time determination 120 can be implemented in various ways, such as based on logic of the UE 104(1), sidelink instructions 122 received from a network entity 102, and so forth. Accordingly, based at least in part on the transmission time determination 120, the UE 104(1) performs sidelink transmission 124 to a UE 104(2) and using a determined sidelink transmission time. Various implementations for performing the transmission time determination 120 and the sidelink transmission 124 are detailed throughout this disclosure.

In some wireless communications systems, resource reservation for sidelink is specified, such as for the PC5 interface. The 3GPP Technical Specification (TS) 38.212 v17.2.0 describes the number of allowed reservation made by a UE. The fields defined in each of the 1^{st}-stage Sidelink Control Information (SCI) formats below are mapped to the information bits a₀ to a_{A-1} as follows: Each field is mapped in the order in which it appears in the description, with the first field mapped to the lowest order information bit a₀ and each successive field mapped to higher order information bits. The most significant bit of each field is mapped to the lowest order information bit for that field, e.g., the most significant bit of the first field is mapped to a₀.

For SCI format 1-A is used for the scheduling of Physical Sidelink Shared Channel (PSSCH) and 2^{nd}-stage-SCI on PSSCH. The following information is transmitted by means of the SCI format 1-A:
Priority—3 bits as specified in clause 5.4.3.3 of [12, TS 23.287 v17.4.0] and clause 5.22.1.3.1 of [8, TS 38.321 v17.1.0]. Value ‘000’ of Priority field corresponds to priority value ‘l’, value ‘001’ of Priority field corresponds to priority value ‘2’, and so on.
Frequency resource assignment

$$- ⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3, as defined in clause 8.1.5 of [6, TS 38.214 v17.2.0].
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of [6, TS 38.214 v17.2.0].
Resource reservation period—┌log₂ N_{rsv_period} ┐ bits as defined in clause 16.4 of [5, TS 38.213 v17.2.0], where N_{rsv_period} is the number of entries in the higher layer parameter sl-ResourceReservePeriodList, if higher layer parameter sl-MultiReserveResource is configured; 0 bit otherwise.
Demodulation Reference Signal (DMRS) pattern—┌log₂ Nₚₐₜₜₑᵣₙ ┐ bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList.
2^{nd}-stage SCI format—2 bits as defined in Table 8.3.1.1-1 of TS 38.212 v17.2.0.
Beta_offset indicator—2 bits as provided by higher layer parameter sl-BetaOffsets2ndSCI and Table 8.3.1.1-2 of TS 38.212 v17.2.0.
Number of DMRS port—1 bit as defined in Table 8.3.1.1-3 of TS 38.212 v17.2.0.
Modulation and coding scheme—5 bits as defined in clause 8.1.3 of [6, TS 38.214 v17.2.0].
Additional Modulation and Coding Scheme (MCS) table indicator—as defined in clause 8.1.3.1 of [6, TS 38.214 v17.2.0]: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of [6, TS 38.214 v17.2.0] if higher layer parameter sl-PSFCH-Period=2 or 4; 0 bit otherwise.
Reserved—a number of bits as determined by the following:
   N_{reserved} bits as configured by higher layer parameter sl-NumReservedBits, with value set to zero, if higher layer parameter indicationUEBScheme2 is not configured, or if higher layer parameter indicationUEBScheme2 is configured to ‘Disabled’;
   (N_{reserved}−1) bits otherwise, with value set to zero.
Conflict information receiver flag—0 or 1 bit
   1 bit if higher layer parameter indicationUEBScheme2 is configured to ‘Enabled’, where the bit value of 0 indicates that the UE cannot be a UE to receive conflict information and the bit value of 1 indicates that the UE can be a UE to receive conflict information as defined in Clause 16.3.0 of [5, TS 38.213 v17.2.0];
   0 bit otherwise.

TABLE 8.3.1.1-1
2^{nd}-stage SCI formats

| Value of 2nd-stage | |
|---|---|
| SCI format field | 2nd-stage SCI format |
| 00 | SCI format 2-A |
| 01 | SCI format 2-B |
| 10 | SCI format 2-C |
| 11 | Reserved |

TABLE 8.3.1.1-2
Mapping of Beta_offset indicator values to indexes
in Table 9.3-2 of [5, TS38.213 v17.2.0]

| Value of | |
|---|---|
| Beta_offset | Beta_offset index in Table 9.3-2 of |
| indicator | [5, TS38.213] |
| 00 | 1st index provided by higher layer |
| | parameter sl-BetaOffsets2ndSCI |
| 01 | 2nd index provided by higher layer |
| | parameter sl-BetaOffsets2ndSCI |
| 10 | 3rd index provided by higher layer |
| | parameter sl-BetaOffsets2ndSCI |
| 11 | 4th index provided by higher layer |
| | parameter sl-BetaOffsets2ndSCI |

TABLE 8.3.1.1-3
Number of DMRS port(s)

| Value of the Number | |
|---|---|
| of DMRS port field | Antenna ports |
| 0 | 1000 |
| 1 | 1000 and 1001 |

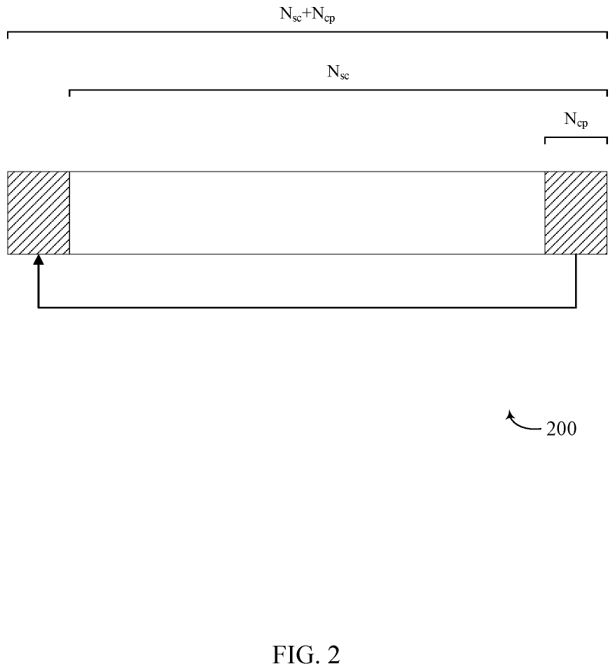

FIG. 2 illustrates an OFDM symbol 200 in which a cyclic prefix is added such as for mitigation of inter-symbol interference. For instance, the OFDM symbol 200 contains N_{sc} samples, the last Nep samples are copied and prepended to the OFDM symbol, resulting in a total of N_{sc}+N_{cp} samples.

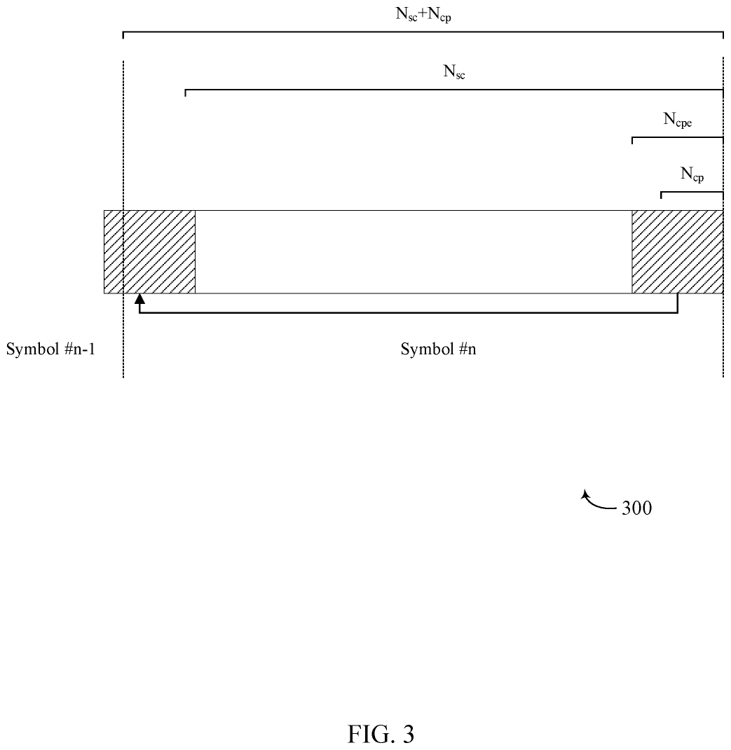

FIG. 3 illustrates an OFDM symbol 300 in which a cyclic prefix is added such as for mitigation of inter-symbol interference in unlicensed carriers. Similar principles can apply as discussed above for the OFDM symbol 200 generation, however with a notable difference: The number of samples copied from the end to the beginning N_{cpe} samples is larger than N_{cp}, while the total duration of the CP-OFDM symbol 300 is still N_{sc}+N_{cp} samples. This means that the first N_{cpe}-N_{cp} samples extend into the duration of the preceding CP-OFDM symbol, as illustrated in FIG. 3, which also shows the symbol boundaries.

In some wireless communications systems OFDM baseband signal generation is implemented for channels except Physical Random Access Channel (PRACH) and RAN Information Management (RIM)-RS. The time-continuous signal

$${s}_{l}^{( p , μ )} ( t )$$

on antenna port p and subcarrier spacing configuration μ for OFDM symbol

$$l ∈ \{ 0 , 1 , … , {N}_{slot}^{subframe , μ} {N}_{symb}^{slot} - 1 \}$$

in a subframe for any physical channel or signal except PRACH is defined by

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix}$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{CP , l}^{μ} {T}_{c} - {t}_{start , l}^{μ} )}$$

$${k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ}$$

$${T}_{s ymb , l}^{μ} = ( {N}_{u}^{μ} + {N}_{CP , l}^{μ} ) {T}_{c}$$

where t=0 at the start of the subframe,

$${N}_{u}^{μ} = 2048 κ \cdot {2}^{- μ}$$

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {2}^{- μ} & normal cyclic prefix , l \neq 0 and l \neq 7 \cdot {2}^{μ}\end{matrix}$$

and
Δf is given by clause 4.2 of TS 38.211 v17.2.0;
μ is the subcarrier spacing configuration;
μ₀ is the largest μ value among the subcarrier spacing configurations by scs-SpecificCarrierList for each of uplink and downlink and by sl-SCS-SpecificCarrierList for sidelink.

In case of cyclic prefix extension of the first OFDM symbol l allocated for Physical Uplink Shared Channel (PUSCH), Sounding Reference Signal (SRS), or Physical Uplink Control Channel (PUCCH) transmission, the time-continuous signal

$${s}_{ext}^{( p , μ )} ( t )$$

for the interval

$${t}_{start , l}^{μ} - {T}_{ext} \leq t < {t}_{start , l}^{μ}$$

preceding the first OFDM symbol for PUSCH, SRS, or PUCCH is given by

$${s}_{ext}^{( p , μ )} ( t ) = {\overline{s}}_{l}^{( p , μ )} ( t )$$

where t<0 refers to the signal in the previous subframe and
for dynamically scheduled PUSCH, SRS, and PUCCH transmissions

$${T}_{ext} = min ( max ( {T}_{ext}^{′} , 0 ) , {T}_{symb , ( l - 1 ) mod 7 \cdot {2}^{μ}}^{μ} )$$

$${T}_{ext}^{′} = {\sum }_{k = 1}^{{C}_{i}} {T}_{symb , ( l - k ) mod 7 \cdot {2}^{μ}}^{μ} - {Δ}_{i}$$

where Δᵢ is given by Table 5.3.1-1 with C₁=1 for μ∈{0,1}, C₁=2 for μ=2, and C₂ and C₃ given by the higher-layer parameters cp-ExtensionC2 and cp-ExtensionC3, respectively, and T_{TA} given by clause 4.3.1 of TS 38.211 v17.2.0. For contention-based random access, or in absence of higher-layer configuration of C₂ and C₃, the value of Cᵢ shall be set to the largest integer fulfilling

$${T}_{ext}^{′} < {T}_{symb , ( l - 1 ) mod 7 \cdot {2}^{μ}}^{μ}$$

for each of the values of i∈{2,3}. Tₑₓₜ is applied to the first uplink (UL) transmission scheduled by the scheduling downlink control information (DCI).
for a PUSCH transmission using configured grant

$${T}_{ext} = {\sum }_{k = 1}^{{2}^{μ}} {T}_{symb , ( l - k ) mod 7 \cdot {2}^{μ}}^{μ} - {Δ}_{i}$$

where Δᵢ is given by Table 5.3.1-2 with the index i given by the procedure in [6, TS 38.214 v17.2.0].

The starting position of OFDM symbol l for subcarrier spacing configuration μ in a subframe is given by

$${t}_{start , l}^{μ} = \{ \begin{matrix}0 & l = 0 \\ {t}_{start , l - 1}^{μ} + ( {N}_{u}^{μ} + {N}_{CP , l - 1}^{μ} ) \cdot {T}_{c} & otherwise\end{matrix}$$

TABLE 5.3.1-1
The variables Cᵢ and Δᵢ for cyclic prefix extension

| Tₑₓₜ index i | Cᵢ | Δᵢ |
|---|---|---|
| 0 | — | — |
| 1 | C₁ | 25 · 10⁻⁶ |
| 2 | C₂ | 16 · 10⁻⁶ + T_{TA} |
| 3 | C₃ | 25 · 10⁻⁶ + T_{TA} |

TABLE 5.3.1-2
The variable Δᵢ for cyclic prefix extension with configured grants.

| index i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | ${\sum }_{k = 1}^{{2}^{μ}} {T}_{symb , ( l - k ) mod 7 \cdot {2}^{μ}}^{μ}$ |

To improve on challenges presented in sidelink transmissions over unlicensed carriers in some wireless communications systems, the present disclosure details solutions for configuration of sidelink transmission. In the discussion in this disclosure, different starting positions and/or cyclic prefix extension durations are represented by a temporal value, e.g. 16 microseconds (μs). This convention is presented for purpose of discussion and may be interpreted in a broad sense to encompass, e.g., an equivalent number of digital samples that may depend on the sampling frequency or the duration of a sample in a communication system. For example, in a 3GPP NR multicarrier communication system operating with a subcarrier spacing of 15 kHz and a Fast Fourier transform (FFT)/Inverse FFT (IFFT) size of 4096, the sampling frequency is 61.44 MHz and the duration of a sample is around 16.276 nanoseconds (ns). Consequently a value of 16 us can be seen as equivalent to a next higher or lower number of samples that are closest to 16 μs, e.g., 983 or 984 samples. Likewise a value of 25 us for that numerology can be seen as equivalent to 1536 samples. Furthermore, 3GPP NR standard 38.211 v17.2.0 expresses the size of various fields in time units T_{c}=1/(Δfₘₐₓ×N_{f}) where Δfₘₐₓ=480×10³ Hz and N_{f}=4096, resulting in T_{c}=1/(1966080000). Therefore a value of 16 μs can be seen as equivalent to 31457 or 31458 time units T_{c}, and likewise a value of 25 μs can be seen as equivalent to 49152 time units T_{c}.

In the following, it should be understood that “starting the transmission” and similar wording on an unlicensed carrier may involve a prior success of a clear channel assessment (CCA), e.g., by following a listen before talk (LBT) procedure. Further, “attempting a transmission” and similar wording may involve undergoing a CCA procedure to determine whether channel access and transmission over the channel is allowed.

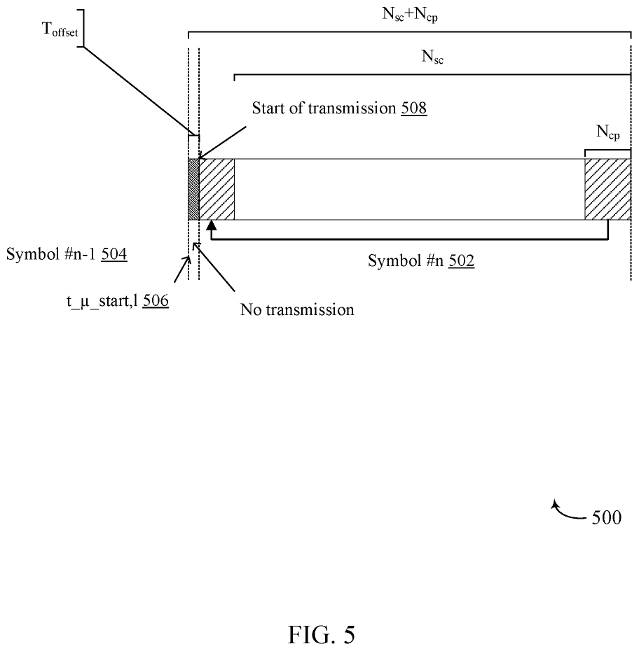

In implementations, a SL UE can determine possible transmission starting positions in a symbol by corresponding configuration of the resource pool (RP) in which the transmission is to take place. For instance, a RP may configure one or more allowed starting positions. According to an implementation, a UE may use any of the allowed starting positions in a symbol. See, for example, FIG. 5 and accompanying discussion below. For example, if a CCA has not been successful for a first allowed starting position in a slot, the UE may continue the CCA in order to determine if for one of the later allowed starting positions the CCA has been successful and the UE may start transmissions at the appropriate starting position.

In implementations, a UE may choose any one of the allowed starting positions in a slot. If a CCA has not been successful for a chosen allowed starting position in a symbol, the UE may not attempt to transmit at a later time within the same symbol. According to a specific implementation, the UE chooses allowed starting position(s) by a random procedure.

In implementations, a SL UE may start transmissions from one or more allowed starting positions at or after the start of a symbol boundary. A plurality of allowed starting positions may include maximum gap durations for which no CCA or a CCA with a fixed contention window size is to be implemented. For instance, for a sidelink transmission on an unlicensed carrier in FR1 the allowed starting positions can include one or more of {0 μs, 16 μs, 25 μs} after the beginning of the symbol boundary.

In implementations, a UE may use any of the allowed starting positions in a symbol. For example, if a CCA has not been successful for the first allowed starting position in a slot, the UE may continue the CCA in order to determine if for one of the later allowed starting positions the CCA is successful and if so, the UE may start transmissions at the appropriate starting position.

In implementations, a UE may choose a starting position from allowed starting positions in a symbol. If a CCA has not been successful for the chosen allowed starting position in a symbol, the UE may not attempt to transmit at a later time within the same symbol. According to at least one implementation, the UE chooses the one of the allowed starting positions by a random procedure.

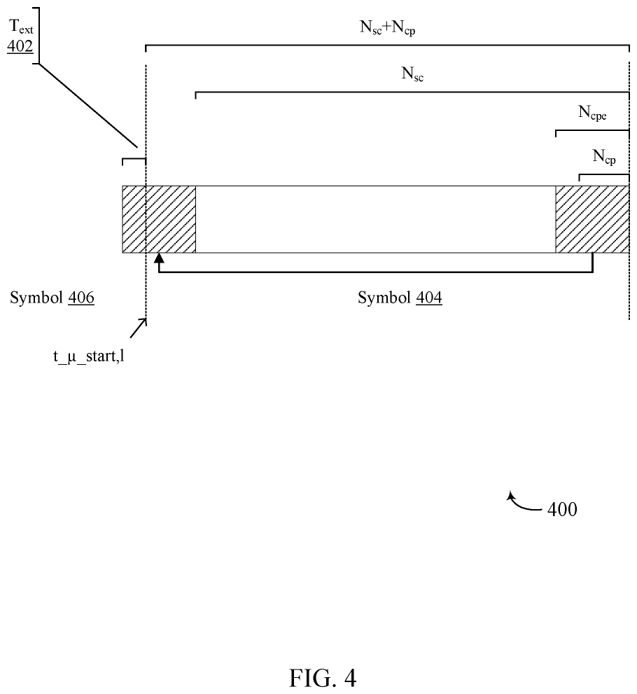

FIG. 4 illustrates a scenario 400 where a sidelink UE may start transmission before a start of a symbol boundary in accordance with aspects of the present disclosure. For instance, a SL transmission starts at time

$${t}_{start , l}^{μ} - {T}_{ext} .$$

This can be implemented, for example, using a “cyclic prefix extension” (CPE) 402, where the cyclic prefix at the beginning of a symbol 404 (Symbol n) is extended by a first duration into a preceding symbol 406, Symbol n−1.

In implementations, a UE may use any of the allowed starting positions in a symbol. For example, if a CCA has not been successful for the first allowed starting position in a symbol, the UE may continue the CCA in order to determine if for one of later allowed starting positions the CCA is successful, and the UE may start transmissions at the appropriate starting position.

In implementations, a UE may choose any one of the allowed starting positions in a symbol. If a CCA has not been successful for the chosen allowed starting position in a symbol, the UE may not attempt to transmit at a later time within the same symbol. For instance, the UE chooses the one of the allowed starting positions by a random procedure.

In implementations, a SL UE can apply a starting transmission time offset in accordance with a priority of its SL transmission. For instance, a starting transmission time offset may be implemented by starting SL transmission prior to the start of a symbol boundary, e.g., by a cyclic prefix extension discussed above or by starting SL transmission after the start of a symbol boundary as discussed above.

FIG. 5 illustrates a scenario 500 where a SL transmission may start after a symbol boundary in accordance with aspects of the present disclosure. The scenario 500 includes a symbol 502 (Symbol n) and a previous symbol 504, Symbol n−1. Further, the scenario 500 illustrates a symbol boundary 506 and a transmission start time 508. For instance, in the scenario 500 a starting time of a UE's transmission can be expressed as

$${t}_{start , l}^{μ} + {T}_{offset} ,$$

where a positive value of T_{offset} indicates the start of a transmission after the start of a symbol boundary.

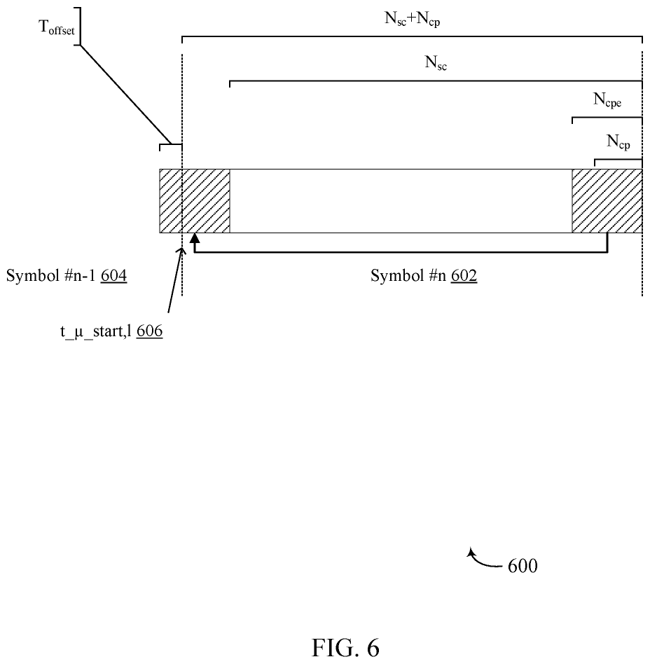

FIG. 6 illustrates a scenario 600 where SL transmission starts before a symbol boundary in accordance with aspects of the present disclosure. The scenario 600 includes a symbol 602 (Symbol n) and a previous symbol 604, Symbol n−1. Further, the scenario 600 illustrates a symbol boundary 606. According to implementations, a negative value of T_{offset} can indicate a start of a transmission before the start of a symbol boundary. Further, a value of T_{offset}=0 can indicate a start of a transmission at the start of a symbol boundary.

In implementations, a T_{offset} value for a higher priority SL transmission is smaller than or equal to the T_{offset} value for a lower priority SL transmission. For example, this applies whether a higher priority is associated with a higher priority value or a lower priority value. For example, a “priority index” and/or a “priority field” can associate a larger value with a higher priority. Conversely, a “channel access priority class” (CAPC) can associate a larger value with a lower priority.

In implementations, each value representable by a “priority index” or a “Priority” field can be associated with a T_{offset} value. Further, a UE can determine a priority of its SL transmission based on the determined CAPC for the channel access.

In implementations, a UE determines the priority of SL transmission based on the priority determined as outlined in clause 5.22.1.3.1 of 38.321 v17.2.0. According to an implementation, the priority or T_{offset} value associated with one or more of the following transmissions are pre-configured. The pre-configuration can be done by the network, by means of a UE-specific RRC signal, and/or based on a configuration for a resource pool.
Physical Sidelink Feedback Channel (PSFCH)
Positioning Reference Signals (PRS).
SCI without transport block transmission
Media access control (MAC) control element (CE)

In implementations, the application of a time offset for starting a transmission may be done by a first device, such as if the first device is aware that a second device intends to transmit in a same resource such as a symbol or slot (alternatively or additionally, a same time-frequency resource) partially or fully. For example, a second UE may announce by means of SCI transmission reserved resources. The SCI may be read and interpreted by the first device in order to determine the resources reserved by the second device. In some wireless communications systems using a licensed carrier, a first device may not attempt to transmit on reserved resources. However, on an unlicensed carrier such “overbooking” may be allowed for more efficient use of the radio resource. For instance, even though the second device has reserved the resource, it may ultimately not be able to transmit on the reserved resource, e.g., due to a failed CCA. Allowing an attempt by a first device to then access such a reserved resource may still succeed.

In implementations it may be preferable to implement such overbooking by a first device on a reserved resource with a positive time offset value, e.g., T_{offset}>0 (or greater/greater or equal to a preconfigurable time offset value) to ensure that a second device that has reserved a resource has priority to use the channel, e.g., is not pre-empted by a first device. Accordingly, a device that attempts transmission on a resource that it has reserved for itself may apply a negative or zero time offset value, e.g., T_{offset}≤0 (or lesser/lesser or equal to a preconfigurable time offset value) for that transmission.

In implementations, a device that is attempting to transmit or starts a transmission on a non-reserved resource (e.g., other than a resource that the device has reserved for itself, i.e. on a resource for which it is not aware of reservation by another device) applies an offset value of T_{offset}=0.

In implementations, the applicability of a time offset, conditions when a time offset should be applied, and/or time offset values or value ranges, may be pre-configured to a UE by a gNB and/or may be part of a resource pool configuration applicable to one or more UEs. Further, whether resource overbooking (e.g., attempting to transmit on a resource that has been reserved by another device) is allowed may be pre-configured to a UE by a gNB and/or may be part of a resource pool configuration applicable to one or more UEs.

For purposes of illustration but not limitation, specific values or value ranges that are eligible for the time offset value may be preferably upper and or lower bounded by one of #{25 μs, 16 μs, 25 μs+T_{TA}, 16 μs+T_{TA}}, where T_{TA} is a timing advance value applicable to a device's transmissions.

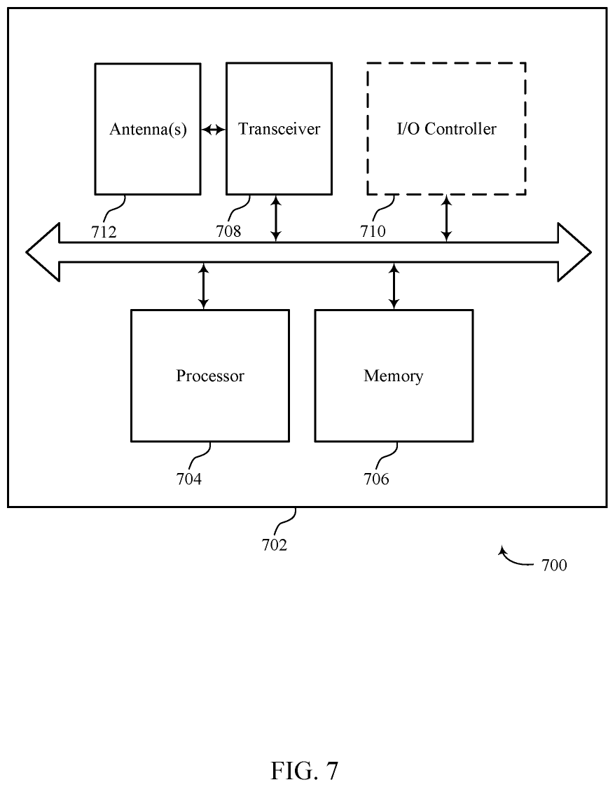

FIG. 7 illustrates an example of a block diagram 700 of a device 702 (e.g., an apparatus) that supports configuration of sidelink transmission in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as or otherwise support a means to generate a transmission; and transmit the transmission over a sidelink resource and at a first time instant, the first time instant determined from a symbol boundary time instant and a first start transmission time offset, and the first start transmission time offset is determined based at least in part on a first transmission priority for the transmission.

Further, in some implementations, the sidelink resource occurs in unlicensed spectrum; the symbol boundary includes a slot boundary; the first start transmission time offset for the first transmission priority is smaller than a second transmission time offset for a second transmission priority, and where the first transmission priority is higher than the second transmission priority; the processor is further configured to: determine whether the sidelink resource is reserved by a second apparatus; and determine the first start transmission time offset as a non-zero value based at least in part on a determination that the sidelink resource is reserved by a different apparatus; the processor is further configured to: determine whether the first transmission priority exceeds a transmission priority threshold; and determine the first start transmission time offset as a non-zero value based at least in part on a determination that the first transmission priority exceeds the transmission priority threshold.

Further, in some implementations, the processor is further configured to implement the first start transmission time offset using a cyclic prefix extension if the first start transmission time offset has a negative value; the processor is further configured to perform a clear channel assessment for the sidelink resource before transmitting the transmission over the sidelink resource; the processor is further configured to determine the first transmission priority based at least in part on a resource pool for the sidelink resource; the processor is further configured to transmit the transmission over the sidelink resource and at the first time instant based at least in part on a failure of a clear channel assessment at a second time instant and a success of a clear channel assessment at the first time instant; the processor is further configured to determine the first time instant as occurring before the symbol boundary time instant; the processor is further configured to receive, from a second apparatus, a notification to apply the first start transmission time offset based at least in part on the first transmission priority.

The processor 704 of the device 702, such as a UE 104, may support wireless communication in accordance with examples as disclosed herein. The processor 704 includes at least one controller coupled with at least one memory, and is configured to or operable to cause the processor to generate a transmission; and transmit the transmission over a sidelink resource and at a first time instant, the first time instant determined from a symbol boundary time instant and a first start transmission time offset, and the first start transmission time offset is determined based at least in part on a first transmission priority for the transmission. Further, the processor 704 including the at least one controller coupled with the at least one memory is further configured to and/or operable to perform any one or more of the operations described herein with reference to a UE, e.g., a UE 104.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

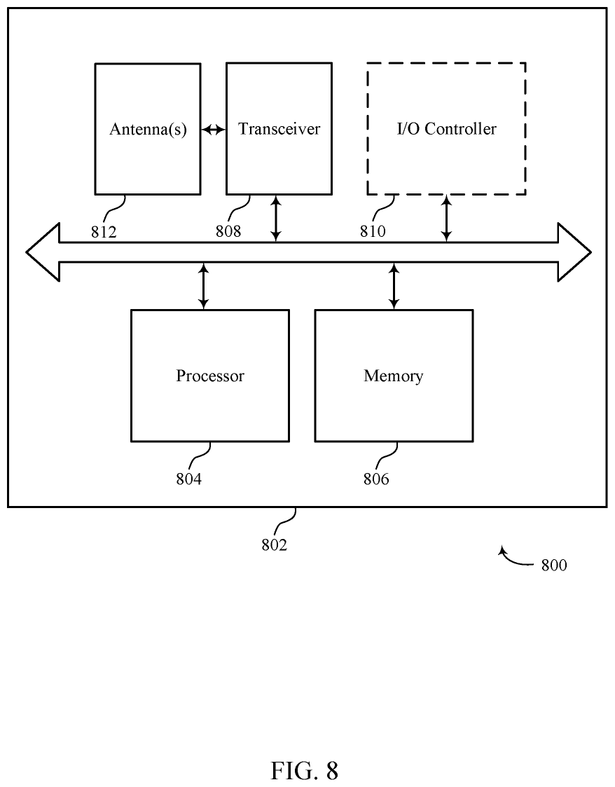

FIG. 8 illustrates an example of a block diagram 800 of a device 802 (e.g., an apparatus) that supports configuration of sidelink transmission in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of network entity 102, for example, the transceiver 808 and the processor 804 coupled to the transceiver 808 are configured to cause the network entity 102 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to generate a notification including one or more transmission priorities for sidelink transmissions and one or more transmission time offsets to be applied to one or more sidelink transmissions associated with the one or more transmission priorities; and transmit the notification to a second apparatus.

Further, in some implementations, the notification indicates that the one or more transmission priorities and the one or more transmission time offsets are to be applied for the one or more sidelink transmissions over unlicensed spectrum; the notification includes a first transmission priority associated with a first transmission time offset and a second transmission priority associated with a second transmission time offset; the first transmission priority is higher than the second transmission priority; and the first transmission time offset is smaller than the second transmission time offset; the notification further includes an indication that when a sidelink resource for a sidelink transmission is determined to be reserved by a third apparatus, the second apparatus is to determine a transmission time offset as a non-zero value.

Further, in some implementations, the notification further includes an indication that when a transmission priority exceeds a transmission priority threshold, the second apparatus is to determine a transmission time offset as a non-zero value; notification further includes an indication to implement at least one transmission time offset using a cyclic prefix extension; In some aspects, the techniques described herein relate to first apparatus, where the notification further includes an indication of association of the one or more transmission priorities with a resource pool for the sidelink transmissions; the notification further includes an indication that at least one transmission time offset is applicable to determine a time instant that occurs before a symbol boundary time instance for a sidelink transmission; the processor is configured to transmit the notification via radio resource control (RRC) signaling.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

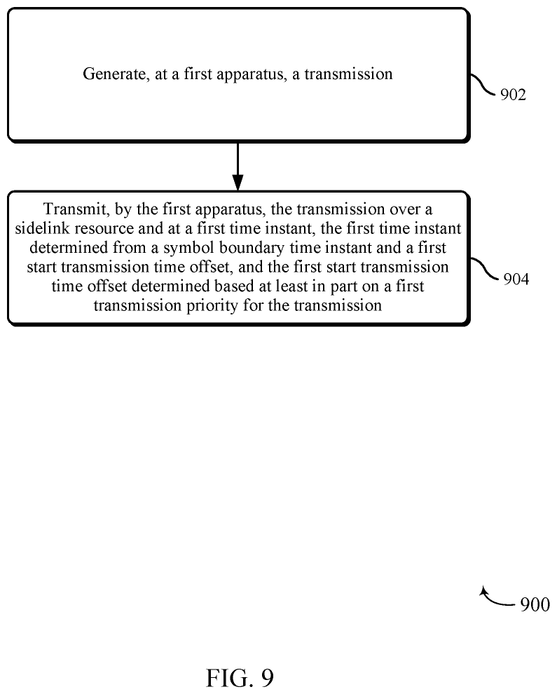

FIG. 9 illustrates a flowchart of a method 900 that supports configuration of sidelink transmission in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include generating, at a first apparatus, a transmission. The operations of 902 may be performed in accordance with examples as described herein. In some implementations, aspects of the operations of 902 may be performed by a device as described with reference to FIG. 1.

At 904, the method may include transmitting, by the first apparatus, the transmission over a sidelink resource and at a first time instant, the first time instant determined from a symbol boundary time instant and a first start transmission time offset, and the first start transmission time offset determined based at least in part on a first transmission priority for the transmission. The operations of 904 may be performed in accordance with examples as described herein. In some implementations, aspects of the operations of 904 may be performed by a device as described with reference to FIG. 1.

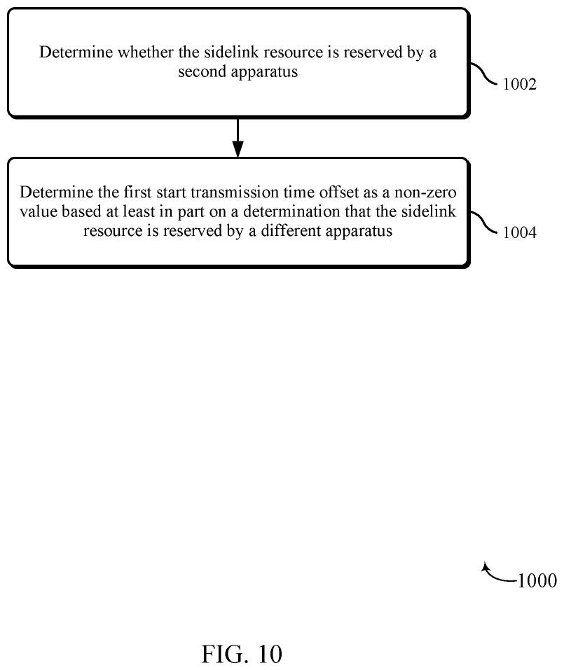

FIG. 10 illustrates a flowchart of a method 1000 that supports configuration of sidelink transmission in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include determining whether the sidelink resource is reserved by a second apparatus. The operations of 1002 may be performed in accordance with examples as described herein. In some implementations, aspects of the operations of 1002 may be performed by a device as described with reference to FIG. 1.

At 1004, the method may include determining the first start transmission time offset as a non-zero value based at least in part on a determination that the sidelink resource is reserved by a different apparatus. The operations of 1004 may be performed in accordance with examples as described herein. In some implementations, aspects of the operations of 1004 may be performed by a device as described with reference to FIG. 1.

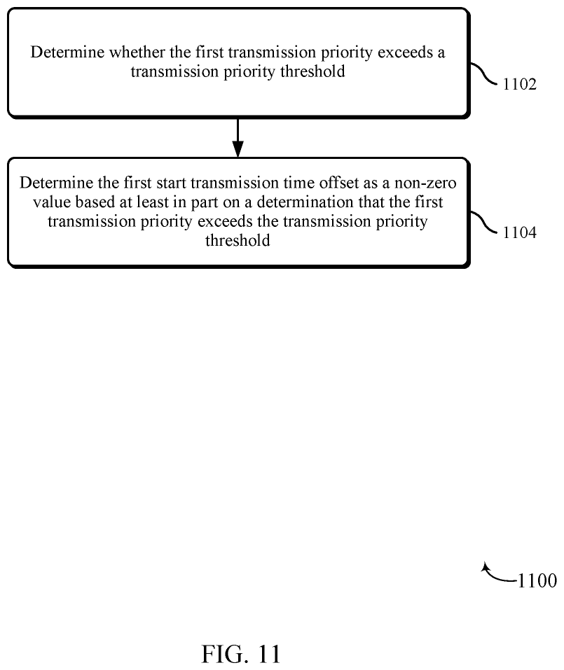

FIG. 11 illustrates a flowchart of a method 1100 that supports configuration of sidelink transmission in accordance with aspects of the present disclosure. The operations of the method 1100 may be implemented by a device or its components as described herein. For example, the operations of the method 1100 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include determining whether the first transmission priority exceeds a transmission priority threshold. The operations of 1102 may be performed in accordance with examples as described herein. In some implementations, aspects of the operations of 1102 may be performed by a device as described with reference to FIG. 1.

At 1104, the method may include determining the first start transmission time offset as a non-zero value based at least in part on a determination that the first transmission priority exceeds the transmission priority threshold. The operations of 1104 may be performed in accordance with examples as described herein. In some implementations, aspects of the operations of 1104 may be performed by a device as described with reference to FIG. 1.

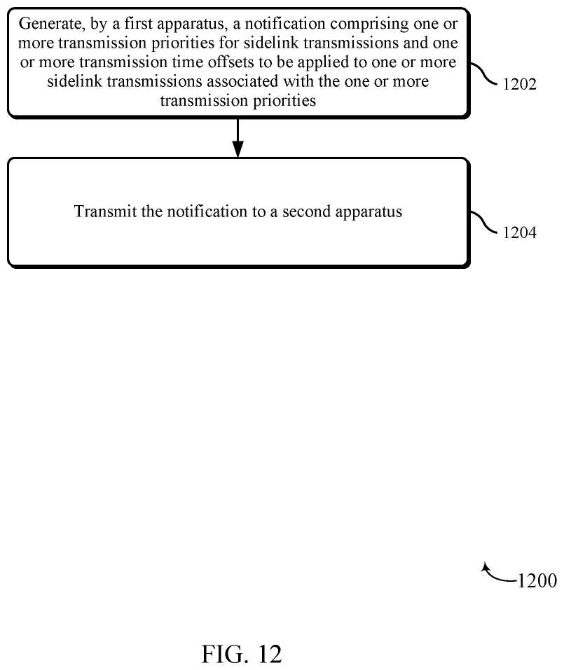

FIG. 12 illustrates a flowchart of a method 1200 that supports configuration of sidelink transmission in accordance with aspects of the present disclosure. The operations of the method 1200 may be implemented by a device or its components as described herein. For example, the operations of the method 1200 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include generating, by a first apparatus, a notification comprising one or more transmission priorities for sidelink transmissions and one or more transmission time offsets to be applied to one or more sidelink transmissions associated with the one or more transmission priorities. The operations of 1202 may be performed in accordance with examples as described herein. In some implementations, aspects of the operations of 1202 may be performed by a device as described with reference to FIG. 1.

At 1204, the method may include transmitting the notification to a second apparatus. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a transmission over a sidelink resource at a first time instant, wherein the first time instant is based at least in part on a symbol boundary time instant and a first start transmission time offset, and the first start transmission time offset is based at least in part on a first transmission priority.

2. The UE of claim 1, wherein the sidelink resource occurs in unlicensed spectrum.

3. The UE of claim 1, wherein the symbol boundary comprises a slot boundary.

4. The UE of claim 1, wherein the first start transmission time offset for the first transmission priority is smaller than a second transmission time offset for a second transmission priority, and wherein the first transmission priority is higher than the second transmission priority.

5. The UE of claim 1, wherein the at least one processor is operable to cause the UE to:
determine whether the sidelink resource is reserved; and
determine the first start transmission time offset as a non-zero value based at least in part on a determination that the sidelink resource is reserved.

6. The UE of claim 1, wherein the at least one processor is operable to cause the UE to:
determine whether the first transmission priority exceeds a transmission priority threshold; and
determine the first start transmission time offset as a non-zero value based at least in part on a determination that the first transmission priority exceeds the transmission priority threshold.

7. The UE of claim 1, wherein the at least one processor is operable to cause the UE to implement the first start transmission time offset using a cyclic prefix extension if the first start transmission time offset has a negative value.

8. The UE of claim 1, wherein the at least one processor is operable to cause the UE to perform a clear channel assessment for the sidelink resource before transmitting the transmission over the sidelink resource.

9. The UE of claim 1, wherein the at least one processor is operable to cause the UE to determine the first transmission priority based at least in part on a resource pool for the sidelink resource.

10. The UE of claim 1, wherein the at least one processor is operable to cause the UE to transmit the transmission over the sidelink resource and at the first time instant based at least in part on a failure of a clear channel assessment at a second time instant and a success of a clear channel assessment at the first time instant.

11. The UE of claim 1, wherein the at least one processor is operable to cause the UE to determine the first time instant as occurring before the symbol boundary time instant.

12. The UE of claim 1, wherein the at least one processor is operable to cause the UE to receive a notification to apply the first start transmission time offset based at least in part on the first transmission priority.

13. A network entity for wireless communication, comprising:
at least one memory; and
at least one processor coupled with the at least one memory and operable to cause the network entity to:
transmit a notification comprising one or more transmission priorities for sidelink transmissions and one or more transmission time offsets to be applied to one or more sidelink transmissions associated with the one or more transmission priorities.

14. The network entity of claim 13, wherein the notification indicates that the one or more transmission priorities and the one or more transmission time offsets are to be applied for the one or more sidelink transmissions over unlicensed spectrum.

15. The network entity of claim 13, wherein the notification comprises a first transmission priority associated with a first transmission time offset and a second transmission priority associated with a second transmission time offset;
the first transmission priority is higher than the second transmission priority; and
the first transmission time offset is smaller than the second transmission time offset.

16. The network entity of claim 13, wherein the notification is transmitted to a first apparatus, and wherein the notification further comprises an indication that when a sidelink resource for a sidelink transmission is determined to be reserved by a second apparatus, the first apparatus is to determine a transmission time offset as a non-zero value.

17. The network entity of claim 13, wherein the notification is transmitted to a first apparatus, and wherein the notification further comprises an indication that when a transmission priority exceeds a transmission priority threshold, the first apparatus is to determine a transmission time offset as a non-zero value.

18. The network entity of claim 13, wherein notification further comprises an indication to implement at least one transmission time offset using a cyclic prefix extension.

19. (canceled)

20. A method performed by a user equipment (UE), the method comprising:
transmitting a transmission over a sidelink resource and at a first time instant, wherein the first time instant is based at least in part on a symbol boundary time instant and a first start transmission time offset, and the first start transmission time offset is based at least in part on a first transmission priority.

21. A method performed by a network entity, the method comprising:
transmitting a notification comprising one or more transmission priorities for sidelink transmissions and one or more transmission time offsets to be applied to one or more sidelink transmissions associated with the one or more transmission priorities.
